(19) United States
(12) Patent Application Publication
(10) Pub. No.: US 2012/0246073 A1
(43) Pub. Date: Sep. 27, 2012

(54) SYSTEMS AND METHODS FOR TRANSFERRING TRANSACTION INSTRUCTIONS FROM A REMOTE REPOSITORY TO A MERCHANT WEBSITE USING A TRANSACTION AGENT

(75) Inventors: Ravindra G. Gore, Fremont, CA (US); Shankar A. Chittoor, Fremont, CA (US); Murali B. Subbarao, Saratoga, CA (US); Allwyn Lobo, Campbell, CA (US)

(73) Assignee: Billeo, Inc., Santa Clara, CA (US)

(21) Appl. No.: 13/417,211

(22) Filed: Mar. 10, 2012

Related U.S. Application Data
(60) Provisional application No. 61/466,001, filed on Mar. 21, 2011.

(51) Int. Cl. G06Q 20/40

(52) U.S. Cl. 705/44

(57) ABSTRACT

Systems and methods for transferring transaction instructions from a remote repository to a participating merchant website using a transaction agent are provided. A user is provided an option of checking out of a merchant website by using a transaction assistant option that requires the user to be authenticated with an activity server. Subsequent to successful authentication, the pre-stored transactional instructions such as user payment method details, the shipping information, and the like are accessed from a payment store and transferred to the transaction terminal at the merchant website for completion of the transaction.

### CROSS-REFERENCE TO RELATED APPLICATION

This application claims benefit to U.S. Provisional Patent Application No. 61/466,001, filed on Mar. 21, 2011, which is incorporated by reference in its entirety.

### TECHNICAL FIELD

The present disclosure is generally related to electronic transactions, and, more particularly, is related to transferring transaction instructions from a remote repository to a participating merchant website using a transaction agent.

### BACKGROUND

Recent years have seen an advent of internet into everyday life. The usage of internet is not restricted to information sharing. Rather, the internet is increasingly used to conduct various e-commerce transactions. Various merchant websites offer several types of consumer products ranging from apparel, jewelry, electronic goods, fashion accessories, and the like. Users find it convenient to buy items on the internet. This saves them the time and hassle of visiting a store and buying the articles in person. Moreover, with the advent of the mobile devices such as laptops, tablet computers, and smart phones, the users have the freedom to engage in online shopping while on the move. Thus, users can indulge in buying items of their choice whenever they find time such as while commuting from work, on a flight, during a break at work, and so forth.

The various merchant websites that offer the facility of online shopping provide a user with an option to select items and put them into a virtual shopping cart. Thereafter, when the user is finished with the shopping, the user can select the checkout option for being directed to a checkout page. The checkout page is a web page where a transaction is initiated. The checkout page includes a payment form in which various payment method details, such as the credit card number, debit card number, expiration date, and so forth need to be filled. Additionally, the user is also required to provide the shipping information that includes address details of the place where the items need to be shipped. Further, the user may provide supplemental information such as shipping method, date of delivery, pay with points, etc.

### SUMMARY

Example embodiments of the present disclosure provide systems of transferring transaction instructions from a remote repository to a participating merchant website using a transaction agent. Briefly described, in architecture, one example embodiment of a system, among others, can be implemented as follows: a transaction agent, an activity server, a transaction instruction repository, and a transaction terminal.

Example embodiments of the present disclosure may also be viewed as providing methods for transferring transaction instructions from a remote repository to a merchant website using a transaction agent. In this regard, one embodiment of such a method, among others, can be broadly summarized by the following steps: adding items to a virtual shopping cart, initiating a checkout, receiving an activation of a transaction agent, authenticating a user with an activity server, presenting one or more user preferences associated with the user, receiving a selection of the one or more user preferences, presenting one or more transaction instructions based on the selected one or more user preferences and one or more supplemental instructions from the activity server, receiving a selection of the one or more transaction instructions and the one or more supplemental instructions, transferring the selected transaction instructions and supplemental instructions to one or more merchant websites; and presenting a confirmation receipt of a transaction completed at the merchant website.

### BRIEF DESCRIPTION OF THE DRAWINGS

FIG. 1 is a block diagram of a system for transferring transaction instructions from an activity server to a merchant website using a transaction agent, in accordance with an example embodiment of the present disclosure.

FIG. 2 is a block diagram of a transaction agent embedded as a plug-in on browser of a computing device or embedded in an application on a computing device, in accordance with an example embodiment of the present disclosure.

FIG. 3 is a block diagram of an activity server interacting with a transaction instruction repository, in accordance with an example embodiment of the present disclosure.

FIG. 4 is a block diagram of a transaction terminal, in accordance with an example embodiment of the present disclosure.

FIG. 5 is a flowchart illustrating a method for transferring transaction instructions from an activity server to a merchant website using a transaction agent, in accordance with an example embodiment of the present disclosure.

FIG. 6 is a flowchart illustrating a method for automatically transferring transaction instructions from an activity server to a merchant website, in accordance with an example embodiment of the present disclosure.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

It may become cumbersome for users to repeatedly enter their payment details, personal information, shipping information, and so forth each time they visit merchant websites for shopping. Moreover, entering such information at merchant websites becomes difficult when performed through a keypad of a mobile device. The small size of the keys renders typing details cumbersome. Thus, it would be advantageous to have systems and methods of enabling the transferring of payment method details, shipping address, and the like without any user input.

The present disclosure relates to methods and systems for transferring transaction instructions from a remote repository to a merchant website using a transaction agent. However, the current state of the art discloses that the transaction instructions are directly provided by the user to a particular merchant site. Alternatively, the transaction may also be completed at a third party site entirely and successfully completed transactions are reported to the merchant. In light of this, the embodiments of the present disclosure enable transfer of transaction instructions from an activity server to a merchant website for transaction processing. Since user transaction instructions are accessed from an activity server along with the user's preferred transaction methods, a user does not need to repeatedly enter transaction instructions whenever they desire to engage in an online transaction activity.

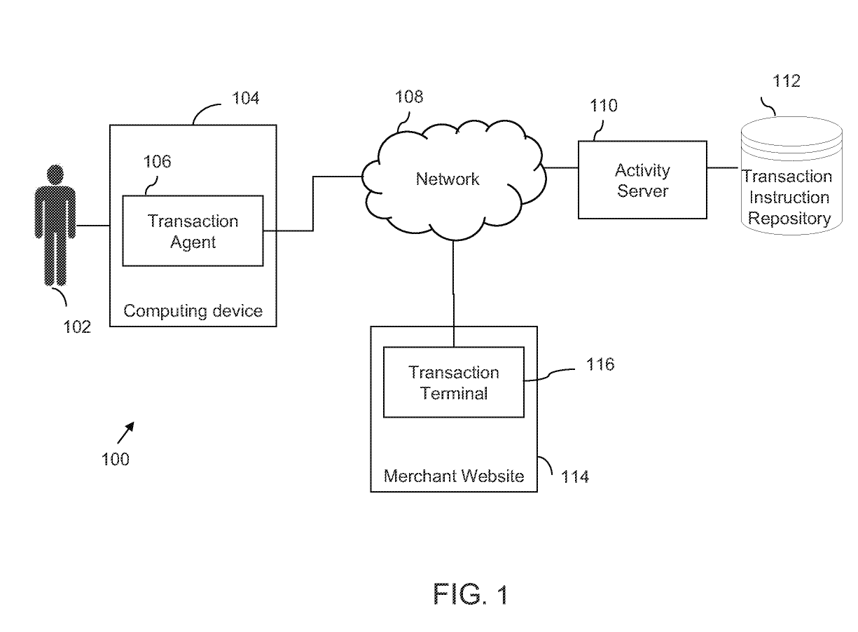

Referring now to FIG. 1, system 100 for transferring transaction instructions from an activity server to a merchant website using a transaction agent is shown in accordance with an example embodiment of the present disclosure. System 100 includes user 102, computing device 104, transaction agent 106, network 108, activity server module 110, transaction instruction repository 112, merchant website 114, and transaction terminal 116.

User 102 may access merchant website 114 using computing device 104 connected to network 108. In an example embodiment of the present disclosure, network 108 is a part of the Internet. In an example embodiment of the present disclosure, computing device 104 is at least one of a desktop computer, a laptop, a mobile phone, a smart phone, a tablet computer, a personal digital assistant (PDA), an Apple iPad and the like. In an example embodiment of the present disclosure, user 102 may purchase from a merchant website 114 using a browser, an application, an app, a mobile app, and the like. User 102 may be displayed merchant website 114 on which user 102 may perform any online transaction. In a scenario in which user 102 decides to purchase items, merchant website 114 enables this by providing a virtual shopping cart in which user 102 may add items that user 102 may select for purchase. Subsequent to selecting all the items to be purchased, user 102 may select a checkout option. User 102 may then be automatically displayed transaction agent 106 as part of the checkout flow. In an example embodiment of the present disclosure, user 102 may manually select transaction agent 106 as part of the checkout flow. Here, transaction agent 106 may be either embedded as a plug-in on a browser of computing device 104 or embedded in an application on computing device 104. Further, transaction agent 106 may provide user 102 with an option to retrieve preferred transactional instructions which are previously stored at activity server 110. Upon activating transaction agent 106, user 102 may be displayed a login screen for authentication with activity server 110. User 102 may provide login credentials for activity server 110 in a login screen, which may be transmitted to activity server 110 through network 108. Activity server 110 may authenticate the user credentials by accessing user credentials previously stored in transactional instruction repository 112.

Subsequent to successful authentication, activity server 110 may access user preferences associated with transactional instructions stored in transactional instruction repository 112. In an example embodiment of the present disclosure, user preferences may include preferred modes of payment such as credit/debit/pre-paid/virtual/gift card, checking/savings/brokerage account, billing addresses, shipping addresses, and the like. These user preferences may be shown to user 102 by transaction agent 106. User 102 may select the user preferences for this specific instance of the transaction, and in a subsequent request to activity server 110, transactional instructions based on the selected user preferences may be downloaded. In an example embodiment of the present disclosure, transaction instruction repository 112 may store the transaction instructions including payment method details such as the credit card number, debit card number, expiration date, card verification value, personal details such as name, billing address, shipping address, and the like. User 102 may then select one or more of the transaction instructions. Further, transaction agent 106 may present to user 102 supplemental instructions such as shipping methods, auto-payment instructions, pay-with-points instructions, recurring transfers setup instructions, and the like. User 102 may then select one or more of the supplemental instructions. Thereafter, the selected transaction instructions and the selected supplemental instructions may be transmitted to transaction terminal 116 present at merchant web site 114. In an example embodiment of the present disclosure, transactional instructions may be sent to multiple merchants at the same time. Here, initially, a user adds one or more items to a virtual shopping cart from multiple merchant websites. Thereafter, when the user wishes to initiate a checkout, transaction agent 106 may fulfill transactions at the multiple merchant websites. In an example embodiment of the present disclosure, auto pay transaction instructions may be delivered to multiple merchants from a bank's website. In this scenario, a user may select auto pay instructions for making bill payments corresponding to one or more merchants through transaction agent 106.

Merchant website 114 may implement transaction terminal 116 which may receive a previously agreed upon format of transaction instructions from transaction agent 106. Transaction terminal 116 may process the received transaction instructions and the supplemental instructions through merchant order processing system. After receiving a confirmation from the merchant order processing system, transaction terminal 116 transmits a confirmation receipt to transaction agent 106. In an example embodiment of the present disclosure, transaction terminal 116 may not be a part of merchant website 114 and transaction terminal 116 may be independent of merchant website 114. Therefore, when transaction terminal 116 is not a part of merchant website 114, transaction terminal 116 interacts with merchant website 114 for completing a transaction.

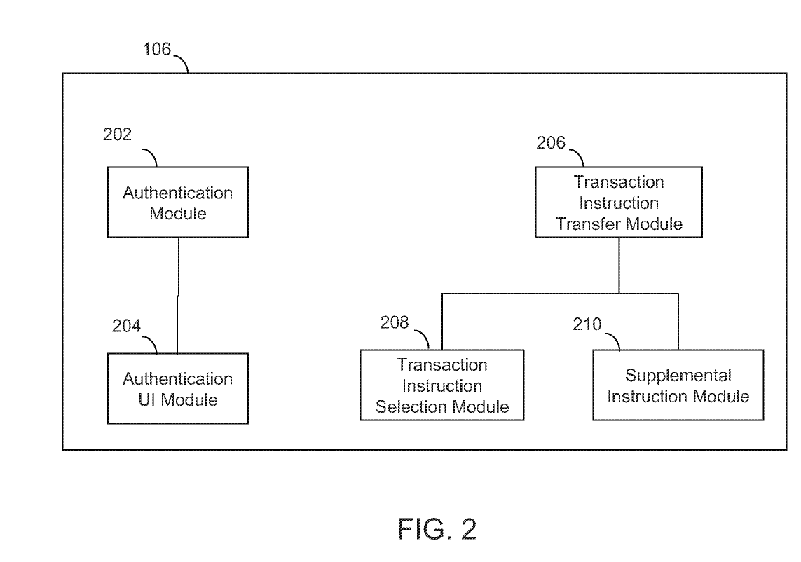

Thereafter, transaction agent 106 presents a confirmation page to user 102. In an example embodiment of the present disclosure, transaction agent 106 may capture confirmation page and details of the transaction confirmation and store it with activity server 110. Further, the transferring of transactional instructions by transaction agent 106 is explained in detail with the explanation of FIG. 2.

Referring now to FIG. 2, transaction agent 106, assisting user 102 in providing transactional instructions stored at activity server 110 during online transaction at merchant website 114 is shown in detail, in accordance with an example embodiment of the present disclosure. Transaction agent 106 includes authentication module 202, authentication user interface (UI) module 204, transaction instruction transfer module 206, transaction instruction selection module 208, and supplemental instruction module 210. In an example embodiment of the present disclosure, transaction agent 106 may be embedded as a plug-in on a browser of computing device 104. In another example embodiment of the present disclosure, transaction agent 106 may be embedded in an application on computing device 104.

Authentication UI module 204 provides a user interface for a login screen used to authenticate user 102. When user 102 has navigated to the checkout page and has activated transaction agent 106, user 102 is provided a login screen by authentication UI module 204. User 102 provides user credentials for activity server 110. Authentication module 202 acts as an interface between transaction agent 106 and activity server 110 for authenticating user 102. In an example embodiment of the present disclosure, authentication module 202 may automatically authenticate user 102 without user input based on user preferences. Here, user credentials may be pre-stored on authentication module 202.

Supplemental instruction module 210 provides supplemental instructions based on merchant website 114. In an example embodiment of the present disclosure, supplemental instructions may be retrieved from user preferences database 312 located at activity server 110. In an example embodiment of the present disclosure, supplemental instruction module 210 may retrieve default supplemental instructions corresponding to user 102 from user preferences database 312 located at activity server 110. In an example embodiment of the present disclosure, user 102 is provided supplemental instructions such as shipping methods, auto-payment instructions, pay-with-points instructions, recurring transfers setup instructions, and the like.

In an example embodiment of the present disclosure, transaction instruction transfer module 206 retrieves user preferences related to the transactional instructions corresponding to user 102 from user preference database 312 located at activity server 110. In an example embodiment of the present disclosure, user preferences include preferred modes of payment such as credit/debit/pre-paid/virtual/gift card, checking/savings/brokerage account, billing address, shipping addresses, and the like. The received user preferences related to the transaction instructions may be displayed to user 102 using transaction instruction selection module 208. After selection of the user preferences by user 102, transaction instruction transfer module 206 may transfer selected user preferences to activity server 110. Thereafter, transaction instruction transfer module 206 may retrieve transaction instructions associated with the selected user preferences of user 102 from payment store 308 located at activity store 110. In an example embodiment of the present disclosure, transaction instructions associated with the selected user preferences may include payment method details such as the credit card number, debit card number, expiration date, card verification value, and the like. In an example embodiment of the present disclosure, transaction instruction transfer module 206 may retrieve default transaction instructions corresponding to user 102 from activity server 110 without needing user 102 to provide those instructions.

Transaction instruction transfer module 206 may transfer transaction instructions associated with selected user preferences and selected supplemental instructions of user 102 to transaction terminal 116 on merchant site 114. Further, transaction instruction transfer module 206 initiates transfer after user 102 verifies selected payment method details and selected shipping details and confirms the purchase. In an example embodiment of the present disclosure, selected transaction instructions and selected supplemental instructions may be transmitted to transaction terminal 116 on merchant site 114 through a specialized uniform resource locator (URL) supported by merchant website 114 across network 108. In an example embodiment of the present disclosure, the specialized URL is a secure link which carries the user payment details and the shipping information in an encrypted manner. Consequently, transaction instruction transfer module 206 of transaction agent 106 receives a confirmation receipt of the transaction from transaction terminal 116 on merchant site 114. Afterwards, transaction instruction transfer module 206 of transaction agent 106 sends the confirmation receipt to activity server 110.

Transaction instruction selection module 208 tracks inputs made by user 102 on the checkout page. In an example embodiment of the present disclosure, the inputs tracked are the selections made by user 102 with respect to user preferences, transaction instructions, and supplemental instructions, confirmation page such as a payment method, billing address, shipping address, and the like. Further, transaction instruction selection module 208 may automatically fill in a payment form displayed at the checkout page using the payment method details received from transaction instruction transfer module 206. In an example embodiment of the present disclosure, transaction instruction selection module 208 displays user preferences related to the transaction instructions, and supplemental instructions of user 102. Moreover, transaction instruction selection module 208 may display a confirmation receipt to user 102.

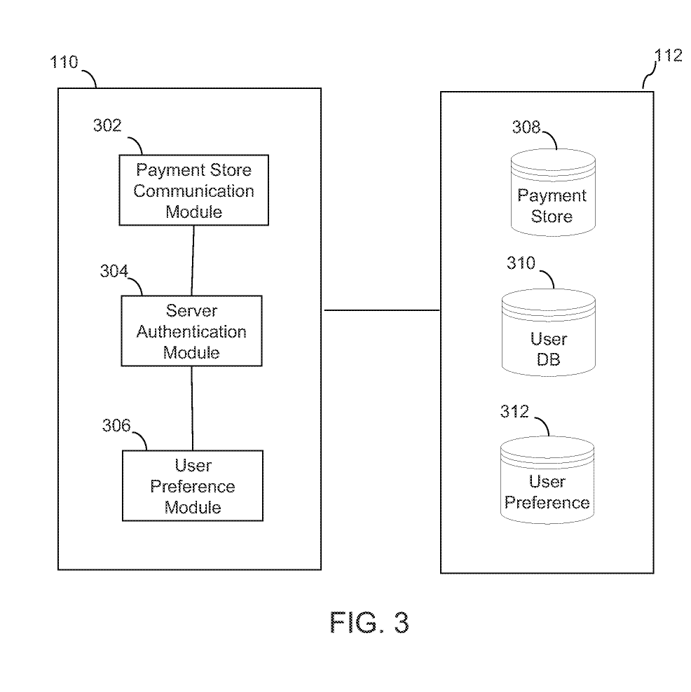

Referring now to FIG. 3, activity server 110 and transactional instruction repository 112 that assist transaction agent 106 in providing transactional instructions during online transaction at merchant website 114 are shown in detail, in accordance with an example embodiment of the present disclosure. Activity server 110 includes payment store communication module 302, server authentication module 304, and user preference module 306. Transactional instruction repository 112 includes payment store 308, user database 310, and user preferences database 312.

Server authentication module 304 authenticates user 102 when user credentials are submitted for activity server 110 against user database 310 which is part of transactional instruction repository 112. In an example embodiment of the present disclosure, payment store communication module 302 and user preferences module 306 may use server authentication module 304 to authenticate user 102 before processing requests. User database 310 stores, using secure encryption, login credentials such as user id and password corresponding to all users registered with activity server 110. These user credentials may be submitted by the authentication module 202 which is part of transaction agent 106. Further, user database 310 stores user profile information such as user ID, gender, age, e-mail address, security questions and the like corresponding to all users registered with activity server 110. This information is captured when a user registers for a service.

User preferences module 306, retrieves the user preferences regarding transactional instructions of user 102 such as preferred mode of payments such as credit/debit/pre-paid/virtual/gift card, checking/savings/brokerage account, billing addresses, shipping addresses and the like. These user preferences are stored in user preferences database 312. User preferences module 306 interacts with the user preferences database 312 to fetch user preferences regarding transactional instructions of user 102. Further, default user preference and all available preferences regarding the transaction instructions are sent to transaction agent 106 using user preferences module 306. Transaction instruction transfer module 206 receives the user preferences and transaction instruction selection module 208 then displays the user preferences for his or her selection. In an example embodiment of the present disclosure, user preferences module 306 may interact with multiple sources having their independent user preference databases located across network 108.

Payment store communication module 302 retrieves transactional instructions from payment store 308 based on selection of user preferences for user 102 such as payment method, shipping address and the like that are requested from transaction instruction transfer module 206. Thereafter, payment store communication module 302 provides the transactional instructions to transaction instruction transfer module 206 to be further passed to transaction terminal 116 on merchant website 114. Further, payment store communication module 302 retrieves supplemental instructions of user 102 from user preference database 312 based on merchant website 114 that are requested from supplemental instruction module 210. In an example embodiment of the present disclosure, payment store 308 may store default transaction instruction details for all users. In an example embodiment of the present disclosure, the default transaction instruction details may include a preferred credit/debit/virtual/pre-paid card number, preferred shipping address, preferred billing address, expiration date, CVV and the like. In an example embodiment of the present disclosure, user preference database 312 may store default supplemental instructions for all users. In an example embodiment of the present disclosure, default supplemental instructions may include a preferred shipping method, a preferred auto-payment instruction, a preferred pay-with-points instruction, a preferred recurring transfer setup instruction, and the like. In an example embodiment of the present disclosure, payment store 308 may be one or more third party payment stores and payment store communication module 302 interfaces with the third party payment stores. Further, the one or more third party stores may be located outside activity server 110.

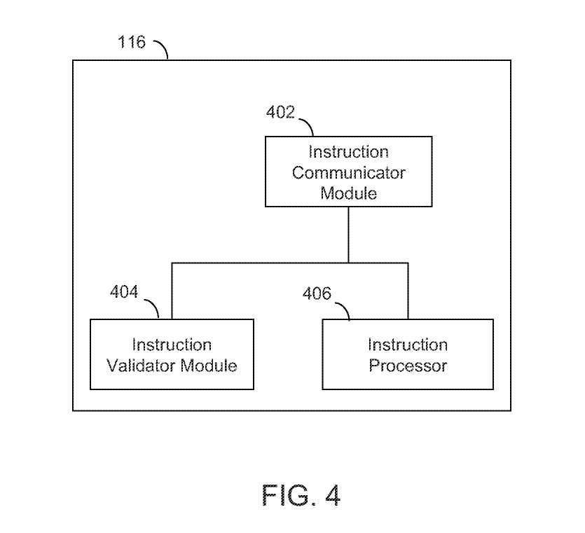

Referring now to FIG. 4, transaction terminal 116 assists in processing transactions is shown in detail, in accordance with an example embodiment of the present disclosure. Transaction terminal 116 includes instruction communicator module 402, instruction validator module 404, and instruction processor 406. In an example embodiment of the present disclosure, transaction terminal 116 may not be a part of merchant website 114 and transaction terminal 116 may be independent of merchant website 114. Therefore, when transaction terminal 116 is not a part of merchant website 114, transaction terminal 116 interacts with merchant website 114 for completing a transaction.

Instruction communicator module 402 listens/receives the selected transaction instructions and the selected supplemental instructions from transaction agent 106. In an example embodiment of the present disclosure, instruction communicator module 402 communicates errors generated by merchant order processing system located at merchant website 114 to transaction agent 106. The errors may include but not limited to Out of Stock, Credit Card failure and the like.

Instruction validator module 404 validates the received transaction instructions and the supplemental instructions. In an example embodiment of the present disclosure, instruction validator module 404 validates the syntax, semantics, schema, and data of the transaction instructions and supplemental instructions.

Instruction processor 406 submits/processes the transaction instructions and the supplemental instructions to merchant order processing system located at merchant website 114. Further, instruction processor 406 sends either success or failure messages to instruction communicator module 406.

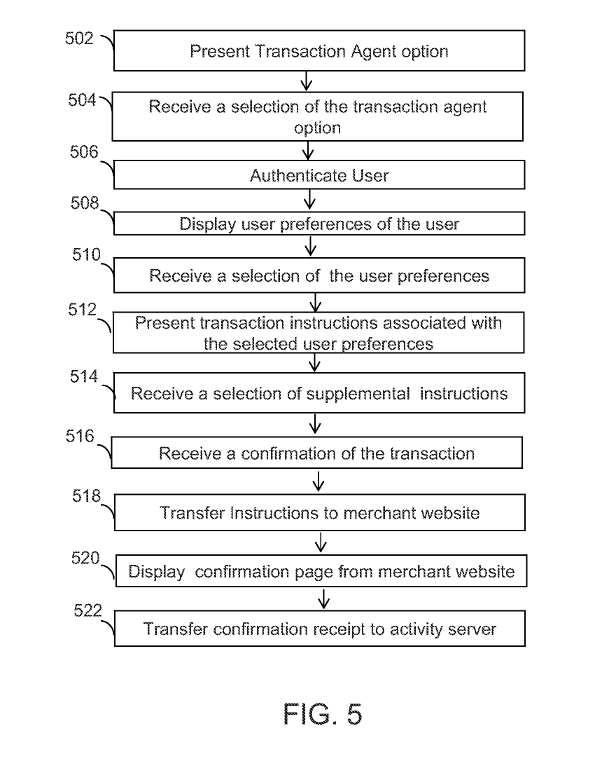

Referring now to FIG. 5, flowchart 500 illustrates a method for transferring transaction instructions from transaction instruction repository 112 to merchant website 114 using transaction agent 106, in accordance with an example embodiment of the present disclosure. FIG. 5 will now be explained in detail in conjunction with FIGS. 1, 2, 3, and 4.

At block 502, user 102 is presented with an option of using transaction agent 106 when user 102 decides to complete a transaction on a merchant website 114 using computing device 104 connected to network 108. In an example embodiment of the present disclosure, network 108 is the Internet. In an example embodiment of the present disclosure, computing device 104 is at least one of a desktop computer, a laptop, a mobile phone, a smart phone, a tablet computer, a personal digital assistant (PDA), an Apple iPad and the like. In an example embodiment of the present disclosure, transaction agent 106 may be embedded as a plug-in on a browser of computing device 104. In another example embodiment of the present disclosure, transaction agent 106 may be embedded in an application on computing device 104.

At block 504, a selection of using transaction agent 106 by user 102 and hence activating transaction agent 106 is received. At block 506, authenticating user credentials provided by user 102. In an example embodiment of the present disclosure, user 102 may be automatically authenticated without inputting user credentials. In an example embodiment of the present disclosure, authentication module 202 of transaction agent 106 transmits the user credentials to activity server 110 for authentication. In an example embodiment of the present disclosure, user database 310 stores login credentials such as user id and password corresponding to all users registered with activity server 110.

Subsequent to successful authentication at block 506, user preferences related to transaction instructions of user 102 are displayed to user 102 for his or her selection at block 508. The user preferences related to transaction instructions of user 102 are retrieved from user preference database 312. In an example embodiment of the present disclosure, the user preferences related to transaction instructions are retrieved by transaction instruction transfer module 206 from user preference database 312 through activity server 110 and displayed to user 102 using transaction instruction selection module 208. In an example embodiment of the present disclosure, user preferences include preferred modes of payment such as credit/debit/prepaid/gift card, checking/savings/brokerage account, billing addresses, shipping addresses, and the like.

At block 510, a selection of user preferences related to transaction instructions of user 102 is received. In an example embodiment of the present disclosure, transaction instruction selection module 208 tracks a selection made by user 102 with respect to the user preferences of user 102. Transaction instructions including payment method details corresponding to the selected user preferences are then accessed from payment store 308 by transaction instruction transfer module 206 and displayed to user 102 using transaction instruction selection module 208 at block 512. In an example embodiment of the present disclosure, transaction instruction transfer module 206 accesses the transaction instructions including payment method details corresponding to the selected user preferences of user 102 from payment store 308 through activity server 110. In an example embodiment of the present disclosure, payment store 308 stores user payment method details such as the credit/debit card number, expiration date, and the like. In an example embodiment of the present disclosure, the payment method details can be changed by user 102.

At block 514, a selection of supplemental instructions based on merchant website 114 such as shipping methods, auto-payment instructions, pay-with-points instructions, recurring transfer setup instructions, and the like is received by user 102. In an example embodiment of the present disclosure, supplemental instruction module 210 may retrieve the supplemental instructions from user preference database 312 located at activity server 110. At block 516, a confirmation of transaction by user 102 using transaction instruction selection module 208 is received. Here, user 102 verifies the transaction instruction details such as the payment method, the billing address, and the shipping address details. Thereafter, at block 518, the selected transaction instructions such as payment method details, the shipping address details, the billing details, and the selected supplemental instructions are transmitted to transaction terminal 116 on merchant website 114 through a uniform resource locator (URL) supported by merchant website 114. At block 520, a confirmation page of transaction is presented to user 102. In an example embodiment of the present disclosure, transaction terminal 116 on merchant website 114 processes the received transaction instructions and the supplemental instructions through merchant order processing system. After receiving a confirmation from the merchant order processing system without any user interaction, transaction terminal 116 transmits a confirmation receipt to transaction agent 106 and transaction agent 106 displays a transaction confirmation page to user 102. Finally, at block 522, confirmation details are transmitted to activity server 110 from transaction instruction transfer module 206 of transaction agent 116. Here, when the transaction confirmation is detected by transaction instruction transfer module 206, transaction instruction transfer module 206 extracts the confirmation receipt from the merchant's response.

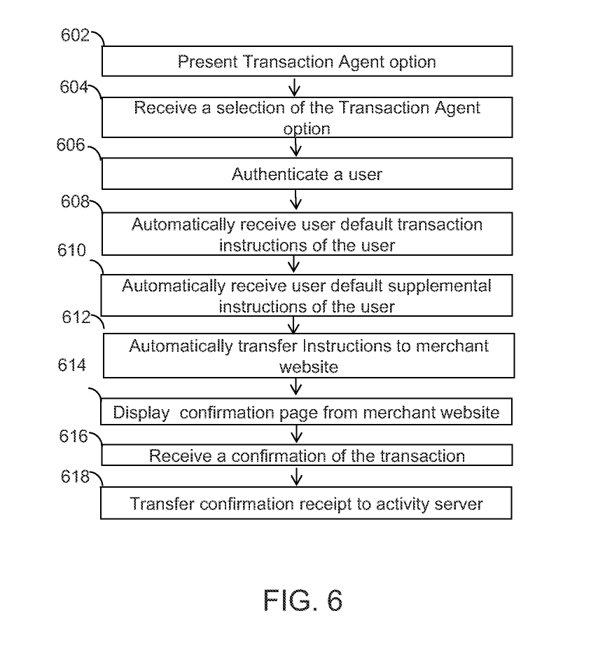

FIG. 6 is a flowchart 600 illustrating a method for transferring transaction instructions from transaction instruction repository 112 to merchant website 114 using transaction agent 106 without any user input, in accordance with an example embodiment of the present disclosure. FIG. 6 will now be explained in detail in conjunction with FIGS. 1, 2, 3, and 4.

At block 602, user 102 is presented with an option of using transaction agent 106 when user 102 decides to complete a transaction on a merchant website 114 using computing device 104 connected to network 108. In an example embodiment of the present disclosure, network 108 is the Internet. In an example embodiment of the present disclosure, computing device 104 is at least one of a desktop computer, a laptop, a mobile phone, a smart phone, a tablet computer, a personal digital assistant (PDA), an Apple iPad and the like. In an example embodiment of the present disclosure, transaction agent 106 may be embedded as a plug-in on a browser of computing device 104. In another example embodiment of the present disclosure, transaction agent 106 may be embedded in an application on computing device 104.

At block 604, a selection of using transaction agent 106 by user 102 and hence activating transaction agent 106 is received. At block 606, authenticating user credentials provided by user 102. In an example embodiment of the present disclosure, user 102 may be automatically authenticated without inputting user credentials.

Subsequent to successful authentication at block 608, default transaction instruction details of user 102 are automatically retrieved from payment store 308 by transaction agent 106 through transaction instruction transfer module 206 at block 610. That is, default transaction instruction details of user 102 are retrieved without any user input. In an example embodiment of the present disclosure, the default transaction instructions may include a preferred credit/debit/virtual/pre-paid card number, preferred shipping address, preferred billing address, expiration date, CVV and the like. At block 612, default supplemental instructions are automatically retrieved from user preference database 312. That is, default supplemental instructions are retrieved without any user input. In an example embodiment of the present disclosure, supplemental instruction module 210 may automatically retrieve default supplemental instructions from user preference database 312. In an example embodiment of the present disclosure, default supplemental instructions may include a preferred shipping method, a preferred auto-payment instruction, a preferred pay-with-points instruction, a preferred recurring transfer setup instruction, and the like. At block 614, the default transaction instruction details and default supplemental transaction instruction details are automatically transmitted to transaction terminal 116 on merchant website 114 through a specialized uniform resource locator (URL) supported by merchant website 114. That is, the default transaction instruction details and default supplemental transaction instruction details are transmitted to transaction terminal 116 on merchant website 114 without any user input. In an example embodiment of the present disclosure, the default transaction instruction details and default supplemental transaction instruction details are transmitted to transaction terminal 116 without any user 102 input. At block 616, a confirmation page of the transaction is presented to user 102. In an example embodiment of the present disclosure, transaction terminal 116 on merchant website 114 processes the received default transaction instruction details and the default supplemental transaction instruction details through merchant order processing system. After receiving a confirmation from the merchant order processing system without any user interaction, transaction terminal 116 transmits a confirmation receipt to transaction agent 106 and transaction agent 106 displays a transaction confirmation page to user 102. Finally, at block 618, activity server 110 receives confirmation receipt from transaction instruction transfer module 206 of transaction agent 116. Here, when the transaction confirmation is detected by transaction instruction transfer module 206, transaction instruction transfer module 206 extracts the confirmation receipt from the merchant's response.

The flow charts of FIG. 5 and FIG. 6 show the architecture, functionality, and operation of a possible implementation of transaction software. In this regard, each block may represent a module, segment, or portion of code, which comprises one or more executable instructions for implementing the specified logical function(s). It should also be noted that in some alternative implementations, the functions noted in the blocks may occur out of the order noted in FIG. 5 and FIG. 6. For example, two blocks shown in succession in FIG. 5 and FIG. 6 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present disclosure has been described in detail, it should be understood that various changes, substitutions and alterations can be made thereto without departing from the spirit and scope of the disclosure as defined by the appended claims.

1. A method of assisting one or more users for performing one or more transactions on one or more merchant websites through a transaction terminal over a network using a transaction agent, the transaction agent being stored on a computing device, the method comprising:
authenticating a user with an activity server for performing the one or more transactions, the activity server being connected with the transaction agent and the one or more merchant websites over the network;
presenting one or more user preferences to the user, the one or more user preferences associated with the one or more users being stored in a user preference database located at the activity server;
receiving a selection of the one or more user preferences;
presenting one or more transaction instructions and one or more supplemental instructions based on the selected one or more user preferences corresponding to the user;
receiving a selection of one of the one or more transaction instructions and one of the one or more supplemental instructions;
transferring the selected transaction instructions and supplemental instructions to the one or more merchant websites; and
presenting a confirmation receipt of a transaction from the one or more merchant website.

2. The method of claim 1, further comprising presenting an option to the user for selecting the transaction agent for assisting in the one or more transactions.

3. The method of claim 2, further comprising receiving a selection of the transaction agent by the user.

4. The method of claim 1, further comprising transmitting the confirmation receipt to the activity server over the network.

5. The method of claim 1, wherein the one or more user preferences comprises one or more payment modes, one or more shipping addresses, and one or more billing addresses.

6. The method of claim 1, wherein the one or more transaction instructions associated with the one or more users is stored in a payment store.

7. The method of claim 1, wherein the one or more supplemental instructions associated with the one or more users is stored in a user preference database.

8. The method of claim 1, wherein the one or more transaction instructions comprises one or more credit card numbers, one or more debit card numbers, one or more expiration dates, and one or more card verification values.

9. The method of claim 1, wherein the one or more supplemental instructions comprises one or more shipping methods, one or more auto-payment instructions, one or more pay-with-points instructions, and one or more recurring transfers setup instructions.

10. A method of assisting one or more users for performing one or more transactions on one or more merchant websites through a transaction terminal over a network using a transaction agent, the transaction agent being stored on a computing device, the method comprising:
authenticating a user with an activity server for performing the one or more transactions, the activity server being connected with the transaction agent and the one or more merchant websites over the network;
transmitting default transaction instructions and default supplemental instructions corresponding to the user to the one or more merchant websites without any user input; and
presenting a confirmation receipt of a transaction from the one or more merchant websites.

11. The method of claim 10, wherein the default transaction instructions and the default supplemental instructions are pre-stored in a payment store and user preference database.

12. A system for assisting one or more users for performing one or more transactions on one or more merchant websites through a transaction terminal over a network using a transaction agent, a transaction agent being independent of the one or more merchant websites, the transaction agent interacting with an activity server, the system comprising:
a. an authentication module for authenticating a user with the activity server;
b. a transaction instruction module for performing steps comprising:
I. retrieving one or more user preferences corresponding to the user based on the authentication;
II. retrieving one or more transaction instructions based on selection of the one or more user preferences by the user;
III. transferring selected one or more transaction instructions and selected one or more supplemental instructions to the one or more merchant websites;
IV. receiving a confirmation receipt of a transaction from the one or more merchant websites; and
V. transmitting the confirmation receipt to the activity server over the network;
c. a supplemental instruction module for retrieving one or more supplemental instructions corresponding to the user from a user preference database located at the activity server; and
d. a transaction instruction selection module for performing steps comprising:
I. presenting the one or more user preferences to the user;
II. receiving a selection of the one or more user preferences;
III. presenting the one or more transaction instructions and the one or more supplemental instructions based on the selected one or more user preferences corresponding to the user;
IV. receiving a selection of the one or more transaction instructions, and the one or more supplemental instructions; and
V. presenting the confirmation receipt of the transaction from the one or more merchant website to the user.

13. The system of claim 12, wherein the one or more user preferences comprises one or more payment modes, one or more shipping addresses, and one or more billing addresses.

14. The system of claim 12, wherein the one or more transaction instructions associated with the one or more users is stored in a payment store.

15. The system of claim 12, wherein the one or more supplemental instructions associated with the one or more users is stored in a user preference database.

16. The system of claim 12, wherein the one or more transaction instructions comprises one or more credit card numbers, one or more debit card numbers, one or more expiration dates, and one or more card verification values.

17. The system of claim 12, wherein the one or more supplemental instructions comprises one or more shipping methods, one or more auto-payment instructions, one or more pay-with-points instructions, and one or more recurring transfers setup instructions.

18. A system for assisting one or more users for performing one or more transactions on one or more merchant websites through a transaction terminal over a network using a transaction agent, a transaction agent being independent of the one or more merchant websites, the transaction agent interacting with an activity server, the system comprising:
a. an authentication module for authenticating a user with the activity server;
b. a transaction instruction module for performing steps comprising:
I. retrieving one or more default transaction instructions based on the authentication without any user input;
II. transferring the one or more default transaction instructions and default one or more supplemental instructions to the one or more merchant websites without any user input; and
III. receiving a confirmation receipt of a transaction from the one or more merchant website;
c. a supplemental instruction module for retrieving one or more default supplemental instructions without any user input corresponding to the user based on the authentication; and
d. a transaction instruction selection module for presenting the confirmation receipt of the transaction from the one or more merchant websites to the user.

19. A computer readable medium comprising computer-executable instructions for performing steps comprising:
authenticating a user with an activity server for performing one or more transactions, the activity server being connected with a transaction agent and one or more merchant websites over a network;
presenting one or more user preferences to the user, the one or more user preferences associated with one or more users being stored in a user preference database located at the activity server;
receiving a selection of the one or more user preferences;
presenting one or more transaction instructions and one or more supplemental instructions based on the selected one or more user preferences corresponding to the user;
receiving a selection of one of the one or more transaction instructions and one of the one or more supplemental instructions;
transferring the selected transaction instructions and supplemental instructions to the one or more merchant websites;
presenting a confirmation receipt of a transaction from the one or more merchant websites.
